(19) United States
(12) Patent Application Publication
(10) Pub. No.: US 2026/0237718 A1
(43) Pub. Date: Aug. 13, 2026

(54) SECONDARY BATTERY

(71) Applicant: Samsung SDI Co., Ltd., Yongin-si (KR)

(72) Inventors: Mun Sung KIM, Yongin-si (KR); Young Bae SONG, Yongin-si (KR); Ji Sang RYU, Yongin-si (KR); Dong Woo KIM, Yongin-si (KR); Deok Hwan SEO, Yongin-si (KR)

(21) Appl. No.: 19/272,931

(22) Filed: Jul. 17, 2025

(30) Foreign Application Priority Data
Feb. 12, 2025 (KR) 10-2025-0017802

(51) Int. Cl. H01M 10/04; H01M 10/0525; H01M 50/559

(52) U.S. Cl. CPC H01M 10/0431; H01M 50/559; H01M 10/0525

(57) ABSTRACT

A secondary battery includes: an electrode assembly including: a positive electrode plate in which a positive electrode active material layer is provided on a positive electrode substrate; a negative electrode plate in which a negative electrode active material layer is provided on a negative electrode substrate; and a separator between the positive electrode plate and the negative electrode plate, and in which the positive electrode plate, the separator, and the negative electrode plate are stacked and then wound along a first direction; and a case in which the electrode assembly is accommodated, wherein the positive electrode plate has a first region having a lower loading level of positive electrode active material than other regions, which is adjacent to a winding center and is at the center of a second direction that is a width direction of the positive electrode plate.

### CROSS-REFERENCE TO RELATED APPLICATION

The present application claims priority to and the benefit of Korean Patent Application No. 10-2025-0017802, filed on Feb. 12, 2025, in the Korean Intellectual Property Office, the entire disclosure of which is incorporated herein by reference.

### BACKGROUND

### 1. Field

Aspects of some embodiments of the present disclosure relate to a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Aspects of some embodiments of the present disclosure include a first region having a relatively low loading level or small thickness of a positive electrode active material layer in a central region adjacent to a winding center in a positive electrode plate of a large-capacity secondary battery.

These and other aspects and features of the present disclosure will be described in or will be apparent from the following description of embodiments of the present disclosure.

A secondary battery according to some embodiments of the present disclosure includes: an electrode assembly which comprises a positive electrode plate in which a positive electrode active material layer is provided on a positive electrode substrate, a negative electrode plate in which a negative electrode active material layer is provided on a negative electrode substrate, and a separator interposed between the positive electrode plate and the negative electrode plate, and in which the positive electrode plate, the separator, and the negative electrode plate are stacked and then wound along a first direction; and a case in which the electrode assembly is accommodated, wherein the positive electrode plate is provided with a first region having a lower loading level of positive electrode active material than other regions, which is adjacent to a winding center and is at the center of a second direction that is a width direction of the positive electrode plate.

According to some embodiments, the first region may extend along the first direction.

According to some embodiments, the first region may be provided in an area of 10% to 70% in the first direction from the winding edge of the positive electrode active material layer.

According to some embodiments, the positive electrode substrate may be a metal foil extending along the first direction, and may include a first surface facing the winding center and a second surface opposite to the first surface and facing the outer periphery of the electrode assembly.

According to some embodiments, the positive electrode active material layer may include a first positive electrode active material layer provided on the first surface of the positive electrode substrate, and a second positive electrode active material layer provided on the second surface of the positive electrode substrate.

According to some embodiments, the first region may be provided in the first positive electrode active material layer.

According to some embodiments, the first positive electrode active material layer and the second positive electrode active material layer may have uniform thicknesses.

According to some embodiments, the positive electrode plate may be provided with a positive electrode uncoated portion on the upper end of the positive electrode substrate, on which the positive electrode active material is not coated, and the negative electrode plate may be provided with a negative electrode uncoated portion on the lower end of the negative electrode substrate, on which the negative electrode active material is not coated.

According to some embodiments, the first region may be provided in an area of 45% to 60% in the second direction from the upper end of the positive electrode active material layer.

According to some embodiments, the positive electrode uncoated portion may be positioned on the upper surface of the electrode assembly, and the negative electrode uncoated portion may be positioned on the lower surface of the electrode assembly.

According to some embodiments, the case may include an upper portion; and a body portion extending downward from an edge of the upper portion, and may further include a terminal penetrating the upper portion of the case and electrically connected to the positive electrode plate.

According to some embodiments, the case may further include a cap plate that seals the lower end of the body portion.

According to some embodiments, the case may include a lower portion; and a body portion extending upward from an edge of the lower portion, and may further include a cap plate sealing an upper end of the body portion.

According to some embodiments, the case may further include a terminal penetrating the cap plate and electrically connected to the positive electrode plate.

A secondary battery according to some embodiments of the present disclosure includes: an electrode assembly which comprises a positive electrode plate in which a positive electrode active material layer is provided on a positive electrode substrate, a negative electrode plate in which a negative electrode active material layer is provided on a negative electrode substrate, and a separator interposed between the positive electrode plate and the negative electrode plate, and in which the positive electrode plate, the separator, and the negative electrode plate are stacked and then wound along a first direction; and a case in which the electrode assembly is accommodated, wherein the positive electrode plate is provided with a first region which is adjacent to a winding center, extends along the first direction, and has a smaller thickness than other regions.

According to some embodiments, the first region may be partially removed from the surface of the first positive electrode active material layer toward the positive electrode substrate, and thus may have a smaller thickness than other regions of the positive electrode active material layer.

According to some embodiments, the first region may be positioned at the center of the second direction, which is the width direction of the positive electrode plate.

According to some embodiments, the first region may be spaced apart from the winding leading edge and from the winding trailing edge.

According to some embodiments of the present disclosure, the secondary battery can be provided in which a first region with a low loading level or a thin thickness of the cathode active material layer is formed in a central area adjacent to the core of the cathode plate, thereby relatively reducing lithium deposition caused by side reactions and relatively improving stress induced by pressure.

However, the characteristics of embodiments of the present disclosure are not limited to the characteristics mentioned above, and other characteristics not mentioned herein will be more clearly understood from the following description by those skilled in the art to which the disclosure belongs.

### BRIEF DESCRIPTION OF DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 is a perspective view showing a secondary battery according to some embodiments of the present disclosure.

FIG. 2 is a cross-sectional view of the secondary battery shown in FIG. 1.

FIG. 3 is a plan view showing a positive electrode plate and a negative electrode plate before an electrode assembly of the secondary battery of FIG. 1 is wound.

FIGS. 4A and 4B show examples of cross-sectional views taken along the line 4-4′ of FIG. 3.

FIG. 5 shows another example of a cross-sectional view taken along the line 4-4′ of FIG. 3.

FIG. 6 is a cross-sectional view showing a secondary battery according to some embodiments of the present disclosure.

FIGS. 7A and 7B are perspective views showing an exemplary battery pack including an exemplary secondary battery according to some embodiments of the present disclosure.

FIGS. 8A and 8B are a perspective view and a side view showing a vehicle including an exemplary battery pack according to some embodiments of the present disclosure.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be arranged in contact with the upper (or lower) surface of the element, and another element may also be interposed between the element and the arbitrary element located on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

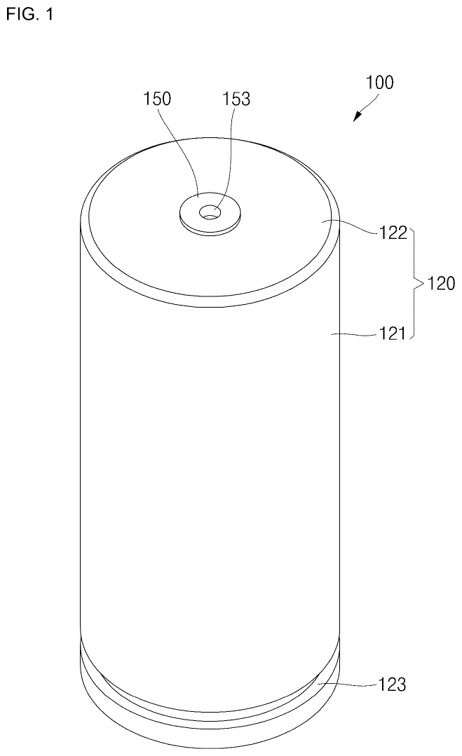

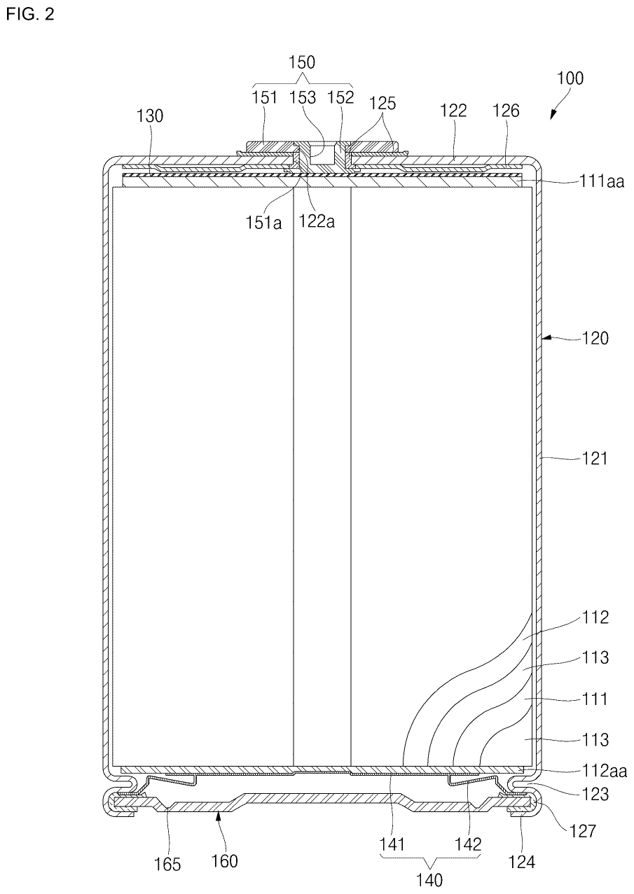

FIG. 1 is a perspective view showing aspects of a secondary battery according to some embodiments of the present disclosure and FIG. 2 is a cross-sectional view of the secondary battery shown in FIG. 1.

As shown in FIGS. 1 and 2, the secondary battery 100 according to some embodiments of the present disclosure may include an electrode assembly 110 and a case 120 in which the electrode assembly 110 and an electrolyte (optional) are accommodated. In addition, the secondary battery 100 may include a terminal 150 coupled to a terminal hole 122a provided at one end of the case 120, for example, at the upper end. In addition, the secondary battery 100 may include a cap plate 160 that seals the other end of the case 110, for example, the lower end. Here, the cap plate 160 is coupled to the case 120 to accommodate the electrode assembly 110 therein, and thus can be considered a part of the case 120.

The secondary battery 100 may further include a positive electrode current collector plate 130 that electrically connects a positive electrode plate 111 of the electrode assembly 110 to the terminal 150, and a negative electrode current collector plate 140 that electrically connects a negative electrode plate 112 of the electrode assembly 110 to the case 120.

The electrode assembly 110 may include a separator 113, the positive electrode plate 111 and the negative electrode plate 112 positioned with the separator 113 positioned therebetween, and may be wound in a jelly-roll shape.

The positive electrode plate 111 may include a positive electrode substrate and a positive electrode active material layer positioned on at least one surface of the positive electrode substrate. A positive electrode tab may extend outward from a positive electrode uncoated portion 111aa of the positive electrode substrate where the positive electrode active material layer is not positioned, and the positive electrode tab may be electrically connected to the terminal 150 through the positive electrode current collector plate 130. The negative electrode plate 112 may include a negative electrode substrate and a negative electrode active material layer positioned on the negative electrode substrate. A negative electrode tab may extend outward from a negative electrode uncoated portion 112aa of the negative electrode substrate where the negative electrode active material layer is not positioned, and the negative electrode tab may be electrically connected to the case 120 through the negative electrode current collector plate 140.

The positive electrode tab and the negative electrode tab may be arranged in opposite directions in the electrode assembly 110. The positive electrode substrate of the positive electrode plate 111 may be composed of aluminum foil, and the positive electrode active material layer may include, for example, a transition metal oxide. The negative electrode substrate of the negative electrode plate 112 may be composed of copper foil or nickel foil, and the negative electrode active material layer may include, for example, graphite.

The separator 113 serves to function to prevent or reduce short circuiting between the positive electrode plate 111 and the negative electrode plate 112 while allowing the movement of lithium ions. The separator 113 may be formed of, for example, a polyethylene film, a polypropylene film, a polyethylene-polypropylene film, etc.

As the positive electrode active material, a compound capable of reversibly intercalating/deintercalating lithium (e.g., a lithiated intercalation compound) may be used. For example, at least one of a composite oxide of lithium or a metal selected from cobalt, manganese, nickel, and/or combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{3-f}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt% to about 99.5 wt% on the basis of 100 wt% of the positive electrode active material layer, and the content of the binder and the conductive material is in a range of about 0.5 wt% to about 5 wt%, respectively, on the basis of 100 wt% of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to some embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer located on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or maWy be in the form of a coating layer containing an organic material and a coating layer containing an inorganic material that are laminated on each other.

The case 120 accommodates the electrode assembly 110 and an electrolyte, and together with the terminal 150 and the cap plate 160, can form the outer shape of the secondary battery 100. The case 120 may include a body portion 121 having a roughly cylindrical shape, and an upper portion 122 connected to one side of the body portion 121. That is, the body portion 121 may extend downward from the edge of the upper portion 122. A beading part 123 deformed toward the inside may be positioned on the body portion 121, and a crimping part 124 bent toward the inside may be positioned on the end of an opening side of the body portion 121. The terminal hole 122a penetrating the center of the upper portion 122 may be provided. The upper portion 122 may be coupled by inserting the terminal 150 into the terminal hole 122a. A terminal gasket 125 for sealing and electrical insulation may be further interposed between the terminal hole 122a and the terminal 150. The upper portion (122) may further be provided with an insulating member 126 on the inner surface to prevent or reduce contact with the electrode assembly 110.

The beading part 123 can prevent or reduce movement of the electrode assembly 110 inside the case 120 and facilitate the seating of the cap gasket 127 and the cap plate 160. The crimping part 124 can firmly or securely affix the cap plate 160 by pressing the edge of the cap plate 160 through the cap gasket 127. The case 120 may be made of, for example, nickel-plated iron, aluminum, an aluminum alloy, or stainless steel.

In the positive electrode current collector plate 130, one surface thereof (e.g., a lower surface) may be in contact with and coupled to the positive electrode tab (positive electrode uncoated portion 111aa) of the electrode assembly 110, and the other surface thereof (e.g., an upper surface) opposite to the one surface may be in contact with and coupled to the terminal 150. The positive electrode current collector plate 130 may be electrically connected by being welded to the positive electrode tab of the electrode assembly 110. The positive electrode current collector plate 130 may be electrically connected by being welded in a state in which the other surface thereof is in contact with the terminal 150.

The negative electrode current collector plate 140 generally has a center portion 141 that may be in contact with and joined to the negative electrode tab (negative electrode uncoated portion 112aa) of the electrode assembly 110 and an edge portion 142 that may be in contact with and coupled to the body portion 121 of the case 120. In the negative electrode current collector plate 140, the center portion 141 may be electrically connected by being welded to the negative electrode tab of the electrode assembly 110. The negative electrode current collector plate 140 may be electrically connected by being welded in a state in which the edge portion 142 is in contact with the beading part 123 of the case 120.

The terminal 150 may include a terminal plate 151 positioned on the outside of the case 120, and a fastening member 152 penetrating the terminal plate 151 and the case 120 to then be coupled thereto. The terminal plate 151 may have a terminal hole 151a passing through the center thereof. The fastening member 152 may penetrating the terminal hole 122a of the upper portion 122 and the terminal hole 151a of the terminal plate 151 from the inside of the case 120 to then be fixed by pressing the terminal plate 151. A terminal gasket 125 for electrical insulation may be interposed between the terminal 150 and the case 120. Here, the terminal gasket 125 may be separately provided with a configuration interposed between the terminal plate 151 and the case 120 and a configuration interposed between the terminal hole 122a and the fastening member 152. In addition, the fastening member 152 may further be provided with a terminal groove 153 in an inward direction from the center. The terminal 150 may be welded to the positive electrode current collector plate 130 through the terminal groove 153 from the outside. The terminal 150 may be electrically connected to the positive electrode plate 111 of the electrode assembly 110 through the positive electrode current collector plate 130. The terminal 150 may have a different polarity from the case 120.

As another example, the terminal 150 may be inserted as a single piece from the outside to the inside of the case 120 through the terminal hole 122a and coupled by riveting on the inside of the upper portion 122.

The cap plate 160 may be fixed to the inside of the crimping part 124 through the cap gasket 127 to seal the case 120. The cap plate 160 may include a safety vent 165 that is thinner than other areas due to a notch. When gas is generated due to overcharging or abnormal operation of the secondary battery 100, the safety vent 165 provided in the cap plate 160 may be cut along the notch. The cut safety vent 165 can prevent or reduce instances of an explosion of the secondary battery 100 by releasing the gas to the outside.

The secondary battery 100 may have a height of approximately 80 mm to approximately 120 mm. Here, the height may be the length ranging from the upper surface of the terminal 150 to the lower surface of the crimping part 124. In addition, the secondary battery 100 may have a diameter (outer diameter) of approximately 46 mm or greater on a plane.

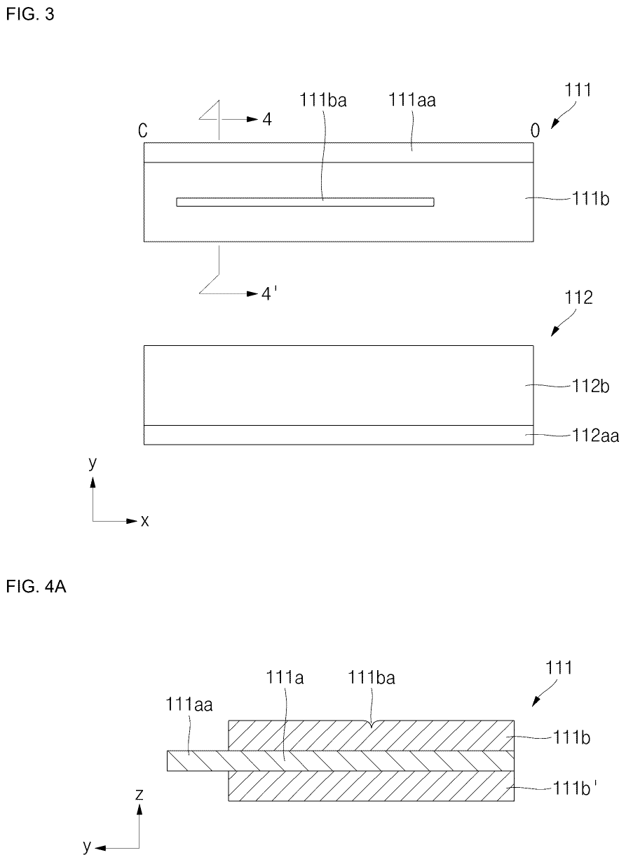

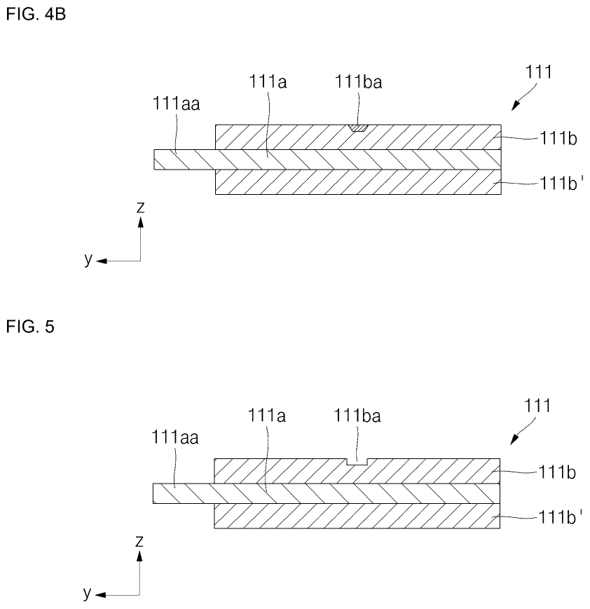

FIG. 3 is a plan view showing a positive electrode plate and a negative electrode plate before the electrode assembly of the secondary battery of FIG. 1 is wound, and FIGS. 4A and 4B show examples of cross-sectional views taken along the line 4-4′ of FIG. 3. Here, FIG. 4A is a cross-sectional view after the positive electrode active material is coated on the substrate of the positive electrode plate, and FIG. 4B is a cross-sectional view after the positive electrode active material is compressed in the positive electrode plate of FIG. 4A.

Here, the positive electrode plate 111 may have a positive electrode active material 111b coated on both sides of a positive electrode substrate 111a. The positive electrode substrate 111a may be a metal foil extending along the first direction (x), which is the longitudinal direction of the positive electrode plate 111.

The positive electrode substrate 111a may include a first surface (or inner surface) and a second surface (or outer surface) opposite to the first surface. Here, the first surface may be a surface facing the winding center in the wound electrode assembly 110, and the second surface may be a surface facing the outer periphery. The positive electrode active material layer 111b may include a first positive electrode active material layer 111b provided on the first surface of the positive electrode substrate 111a and a second positive electrode active material layer 111b′ provided on the second surface. The first positive electrode active material layer 111b and the second positive electrode active material layer 111b′ may be formed continuously from the winding leading edge to the winding trailing edge of the positive electrode substrate 111a. That is, the lengths of the first positive electrode active material layer 111b and the second positive electrode active material layer 111b are the same. The positive electrode active material layers 111b and 111b′ are formed by a stripe coating method.

The positive electrode uncoated portion 111aa may be provided on the upper end of the positive electrode substrate 111a, and may be provided at the same position on the first surface and the second surface of the positive electrode substrate 111a. Here, the positive electrode uncoated portion 111aa may protrude upward from the electrode assembly 110, and may be in contact with and electrically connected to the positive electrode current collector plate 130. In addition, the positive electrode uncoated portion 111aa may be formed continuously from the winding leading edge to the winding trailing edge of the positive electrode substrate 111a. According to some embodiments, when the secondary battery 100 is turned over, the positive electrode uncoated portion 111aa protrudes downward from the electrode assembly 110.

According to some embodiments, the positive electrode uncoated portion 111aa may be separated into multiple tabs by notching or cutting. In this case, the positive electrode uncoated portion 111aa may not be provided in some areas of the winding leading edge (C) and some areas of the winding trailing edge (O). The positive electrode uncoated portion 111aa may be bent by compaction in the winding center axis or outward from the electrode assembly (110) after the electrode assembly 110 is wound, but embodiments according to the present disclosure are not limited thereto.

The first positive electrode active material layer 111b may be coated with a uniform thickness on the first surface of the positive electrode substrate 111a. However, the first positive electrode active material layer 111b may have a first region 111ba having a lower loading level along the first direction (x) at approximately the center of the second direction (y), which is perpendicular to the first direction (x) and the width direction of the positive electrode plate 111. The first positive electrode active material layer 111b may be compressed after being coated on the first surface of the positive electrode substrate 111a, and thus the thickness thereof may be uniform. However, the first region 111ba may be a region having the same thickness as other regions of the first positive electrode active material layer 111b, but having a lower mass per unit area.

The second positive electrode active material layer 111b′ may be coated with a uniform thickness on the second surface of the positive electrode substrate 111a and compressed so that the thickness and loading level may be the same. Here, the loading level of the second positive electrode active material layer 111b′ may be the same as that of the first positive electrode active material layer 111b, and may be greater than that of the first region 111ba. That is, the first region 111ba may be a region having a lower loading level than other regions of the first positive electrode active material layer 111b and the second positive electrode active material layer 111b′.

As the capacity and size of the secondary battery 100 increase, the lengths of the positive electrode plate 111 and the negative electrode plate 112 of the electrode assembly 110 in the first direction (x) and the height in the second direction (y) increase, so that the stress generated at the approximate center of the winding center may also increase. Here, in the secondary battery 100, when the positive electrode plate 111 and the negative electrode plate 112 expand, compared to the winding leading edge portion, the winding trailing edge portion may be advantageous in terms of side reactions due to pressure and stress owing to the free space of the case 120.

When used for a long time, the secondary battery 100 may experience an increase in lithium precipitation due to a lithium side reaction that may occur in the central region where the most pressure may be received at the winding leading edge, resulting in deterioration of battery performance. To prevent or reduce this, in the case of a large-capacity secondary battery 100, like in the present disclosure, by providing the first region 111ba having a low loading level of the positive electrode active material layer in the central region of the second direction (y), where a lithium side reaction highly occurs in an area adjacent to the winding center, lithium precipitation due to the side reaction can be relatively reduced and the stress in the central region can be ameliorated. Here, the positive electrode plate 111 may receive increased stress and pressure on the first surface adjacent to the winding center.

Here, the first region 111 ba may be provided in an area of 10% to 70% in the first direction (x) from the winding leading edge (C) of the first positive electrode active material layer 111b. The first region 111ba may be positioned so as to be spaced apart from the winding leading edge of the first positive electrode active material layer 111b and from the winding trailing edge. That is, the first region 111ba may not be provided in the winding leading edge region and the winding trailing edge region.

In addition, the first region 111 ba may be provided in a region of 45% to 60% in the second direction (y) from the upper end of the first positive electrode active material layer 111b. Here, the side reaction may be more unfavorable in the region adjacent to the negative electrode tab from the center of the second direction (y) of the first positive electrode active material layer 111b.

The negative electrode plate 112 may have the negative electrode active material 112b coated on both sides of the negative electrode substrate 112a. In this case, the loading level of the negative electrode active material 112b coated on the first and second surfaces of the negative electrode substrate 112a may be uniform.

The secondary battery 100 of the present disclosure can relatively reduce and suppress, by means of the first region 111ba, side reactions due to pressure and stress in the winding center area that may occur due to an increase in size and capacity.

FIG. 5 shows another example of a cross-sectional view taken along the line 4-4′ of FIG. 3, which is a cross-sectional view of a positive electrode plate after a positive electrode active material is coated on a substrate and compressed.

After the positive electrode plate 111 is coated with the first positive electrode active material 111b with a uniform thickness and compressed, a portion of the first positive electrode active material 111b in the first region 111ba may be removed. Here, the first region 111ba may be formed by removing a portion of the surface of the first positive electrode active material 111b toward the positive electrode substrate. The cross-sectional shape of the first region 111ba may be changed into various shapes, such as a notch, a square shape, and a semi-arc shape.

The first region 111ba may have a smaller thickness than other regions of the first positive electrode active material 111b. Here, the region where the first region 111ba is located may be the same as the positive electrode plate 111 in FIGS. 4A and 4B, and the same may be true of the configuration of the positive electrode plate 111.

The secondary battery 100 may be provided with the first region 111ba in which the first positive electrode active material 111b has a small thickness in a region where the greatest pressure can be received due to expansion of the negative electrode plate 112, thereby relatively reducing side reactions by a relatively reduced amount of positive electrode active material, and also relatively reducing pressure and stress.

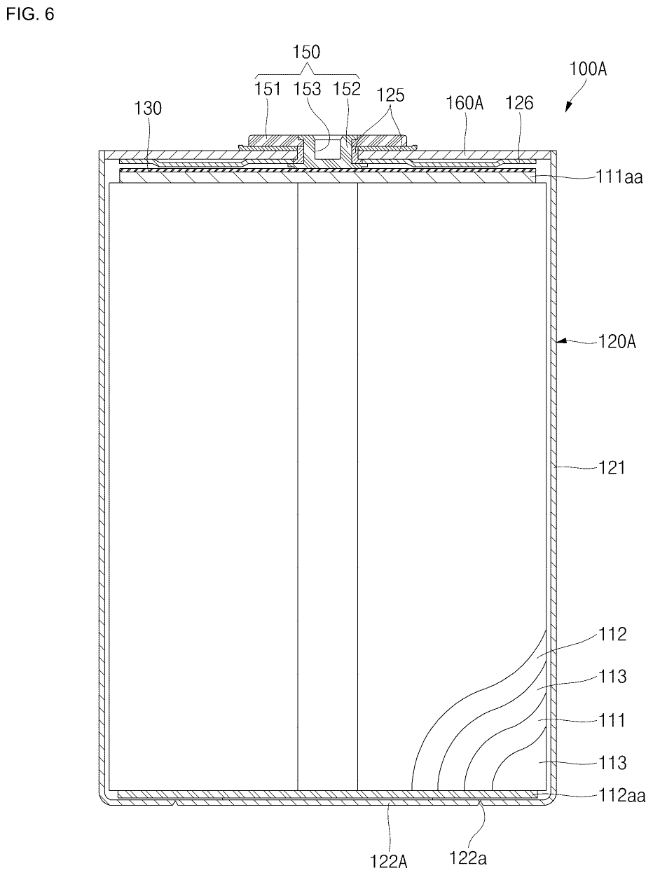

FIG. 6 is a cross-sectional view showing a secondary battery according to some embodiments of the present disclosure. In FIG. 6, the secondary battery 100A may have a terminal 150 connected to a cap plate 160A. In addition, a negative electrode tab 112b of an electrode assembly 110 may be directly welded to a lower portion 122A of a case 120A.

The case 120A may include the lower portion 122A and a body portion 121 extending upward from an edge of the lower portion 122A. In addition, the lower portion 122A may include a safety vent 122a that is thinner than other areas due to a notch. When gas is generated due to overcharging or abnormal operation of the secondary battery 100A, the safety vent 122a provided in the case 120A may be cut along the notch. The cut safety vent 122a may release gas to the outside to prevent or reduce instances of an explosion of the secondary battery 100A.

The cap plate 160A may be coupled by welding to the upper end of the body portion 121. In addition, a terminal 150 may be coupled to a terminal hole provided in the cap plate 160A. Of course, the cap plate 160A and the terminal 150 may be electrically separated by a terminal gasket 125. The other configuration of the secondary battery 100A may be similar to the secondary battery 100 shown in FIGS. 1 and 2.

The secondary battery according to the above-described embodiments can be used to manufacture a battery pack.

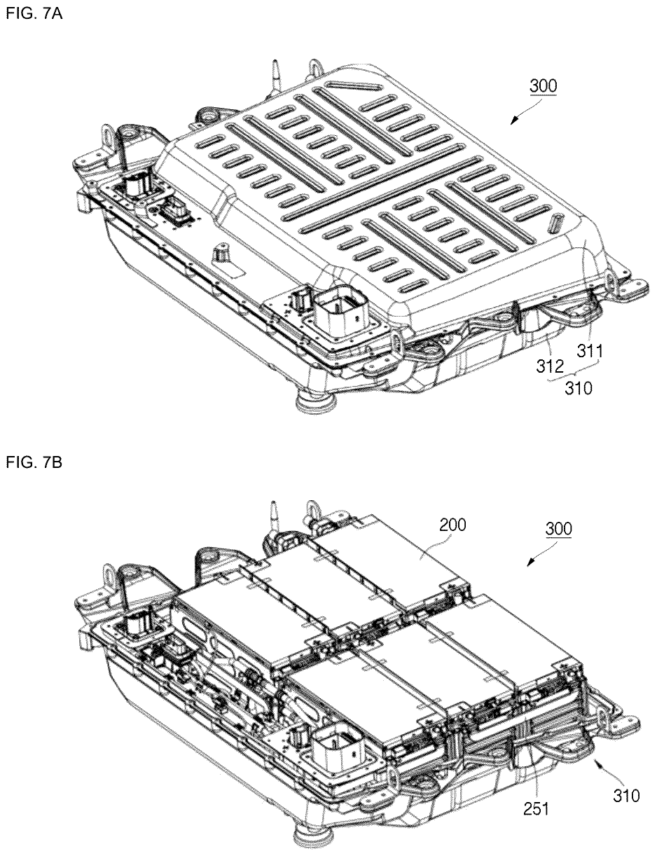

FIGS. 7A and 7B are perspective views showing an exemplary battery pack 300. The battery pack 300 may include a plurality of battery modules 200 and a housing 310 configured to accommodate the plurality of battery modules 200. For example, the housing 310 may include a first housing 311 and a second housing 312, which are coupled to each other in directions facing each other with the plurality of battery modules 200 interposed therebetween. The plurality of battery modules 200 may be electrically connected to each other using bus bars 251. The plurality of battery modules 200 may be electrically connected to each other in series, in parallel, or in a combination thereof, so that desired electrical output may be obtained.

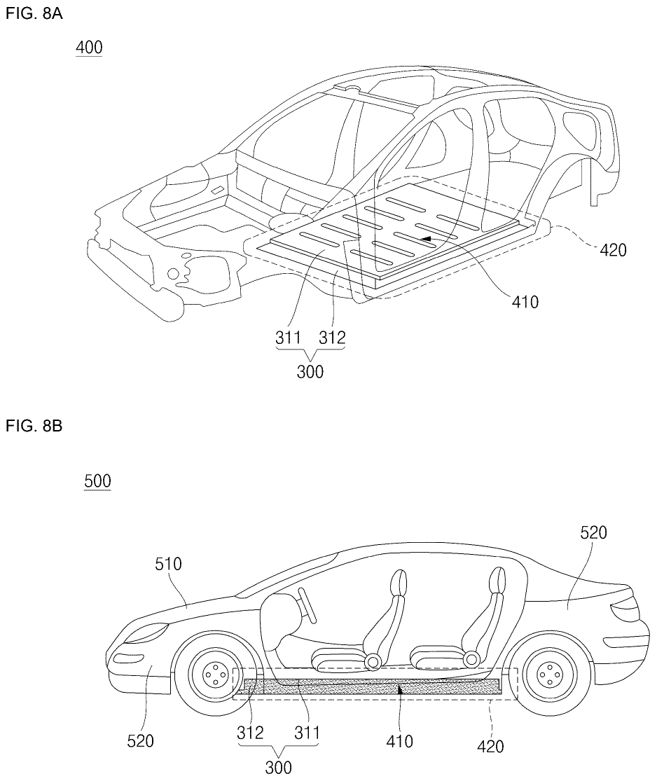

FIGS. 8A and 8B are, respectively, a perspective view showing an exemplary vehicle body 400 and a side view showing an exemplary vehicle 500. As shown in FIG. 8A, the battery pack 300 may include a battery pack cover 311 (which may correspond to the first housing), which is a portion of a vehicle underbody 410, and a pack frame 312 (which may correspond to the second housing), which is located beneath the vehicle underbody 410. The battery pack cover 311 and the pack frame 312 may be integrally formed with a vehicle bottom portion 420. The vehicle underbody 410 may separate the interior and the exterior of the vehicle from each other, and the pack frame 312 may be located outside the vehicle.

As shown in FIG. 8B, the vehicle 500 may include a vehicle body 400 and various parts coupled to the vehicle body 400, such as a hood 510 located at the front portion of the vehicle and fenders 520 located at the front and rear portions of the vehicle. The vehicle 500 may include the battery pack 300 including the battery pack cover 311 and the pack frame 312, and the battery pack 300 may be coupled to the vehicle body 400.

The above describes aspects of some embodiments for implementing a secondary battery according to the disclosure, the disclosure is not limited to the above embodiments, and there is a technical spirit of the disclosure to the extent that various modifications can be made by anyone having ordinary skill in the art to which the disclosure pertains without departing from the gist of the disclosure as claimed in the following claims, and their equivalents.

What is claimed is:

1. A secondary battery comprising:
an electrode assembly comprising:
a positive electrode plate in which a positive electrode active material layer is provided on a positive electrode substrate;
a negative electrode plate in which a negative electrode active material layer is provided on a negative electrode substrate; and
a separator between the positive electrode plate and the negative electrode plate, and in which the positive electrode plate, the separator, and the negative electrode plate are stacked and then wound along a first direction; and
a case in which the electrode assembly is accommodated,
wherein the positive electrode plate has a first region having a lower loading level of positive electrode active material than other regions, which is adjacent to a winding center and is at a center of a second direction that is a width direction of the positive electrode plate.

2. The secondary battery as claimed in claim 1, wherein the first region extends along the first direction.

3. The secondary battery as claimed in claim 2, wherein the first region is in an area of 10% to 70% in the first direction from a winding leading edge of the positive electrode active material layer.

4. The secondary battery as claimed in claim 1, wherein the positive electrode substrate can be a metal foil extending along the first direction, and can comprise a first surface facing the winding center and a second surface opposite to the first surface and facing an outer periphery of the electrode assembly.

5. The secondary battery as claimed in claim 4, wherein the positive electrode active material layer comprises a first positive electrode active material layer on the first surface of the positive electrode substrate, and a second positive electrode active material layer on the second surface of the positive electrode substrate.

6. The secondary battery as claimed in claim 5, wherein the first region is in the first positive electrode active material layer.

7. The secondary battery as claimed in claim 6, wherein the first positive electrode active material layer and the second positive electrode active material layer have uniform thicknesses.

8. The secondary battery as claimed in claim 1, wherein the positive electrode plate has a positive electrode uncoated portion on an upper end of the positive electrode substrate, on which the positive electrode active material is not coated, and the negative electrode plate has a negative electrode uncoated portion on a lower end of the negative electrode substrate, on which the negative electrode active material is not coated.

9. The secondary battery as claimed in claim 8, wherein the first region is in an area of 45% to 60% in the second direction from an upper end of the positive electrode active material layer.

10. The secondary battery as claimed in claim 8, wherein the positive electrode uncoated portion is on an upper surface of the electrode assembly, and the negative electrode uncoated portion is on a lower surface of the electrode assembly.

11. The secondary battery as claimed in claim 1, wherein the case comprises an upper portion; and a body portion extending downward from an edge of the upper portion, and further comprises a terminal penetrating the upper portion of the case and electrically connected to the positive electrode plate.

12. The secondary battery as claimed in claim 11, wherein the case further comprises a cap plate that seals a lower end of the body portion.

13. The secondary battery as claimed in claim 1, wherein the case comprises a lower portion; and a body portion extending upward from an edge of the lower portion, and further comprises a cap plate sealing an upper end of the body portion.

14. The secondary battery as claimed in claim 13, wherein the case further comprises a terminal penetrating the cap plate and electrically connected to the positive electrode plate.

15. A secondary battery comprising:
an electrode assembly comprising:
a positive electrode plate having a positive electrode active material layer on a positive electrode substrate;
a negative electrode plate having a negative electrode active material layer on a negative electrode substrate; and
a separator between the positive electrode plate and the negative electrode plate, and in which the positive electrode plate, the separator, and the negative electrode plate are stacked and then wound along a first direction; and
a case in which the electrode assembly is accommodated, wherein the positive electrode plate has a first region adjacent to a winding center, extends along the first direction, and has a smaller thickness than other regions.

16. The secondary battery as claimed in claim 15, wherein the first region is partially removed from a surface of the positive electrode active material layer toward the positive electrode substrate, and thus has a smaller thickness than other regions of the positive electrode active material layer.

17. The secondary battery as claimed in claim 15, wherein the first region is positioned at a center of a second direction, which is a width direction of the positive electrode plate.

18. The secondary battery as claimed in claim 15, wherein the first region is spaced from a winding leading edge and from a winding trailing edge.
